(19) United States
(12) Patent Application Publication
(10) Pub. No.: US 2011/0196589 A1
(43) Pub. Date: Aug. 11, 2011

(54) METHOD FOR COMPENSATING FOR VOLUME CHANGES OF AN HYDRAULIC FLUID IN AN HYDRAULIC ACTUATING DEVICE FOR ACTUATING A CLUTCH, AND HYDRAULIC ACTUATING DEVICE

(76) Inventors: Werner Urban, Vaihingen/Enz (DE); Mykhaylo Klymenko, Gerlingen (DE)

(21) Appl. No.: 12/737,768

(22) PCT Filed: Jul. 24, 2009
(86) PCT No.: PCT/EP2009/059619

§ 371 Date: Apr. 27, 2011

(30) Foreign Application Priority Data
Aug. 19, 2008 (DE) 102008041353.4

(51) Int. Cl. F16D 48/06; F16D 48/02

(52) U.S. Cl. 701/68; 192/85.01

(57) ABSTRACT

In a method for compensating for volume changes of a hydraulic fluid in an actuating device used for actuating a clutch, which actuating device includes a master cylinder, an actuator connected to a piston of the master cylinder, and a slave cylinder hydraulically connected to the master cylinder for disengaging the clutch. The position of the piston of the master cylinder is corrected as a function of temperature and that the actuating device include an element for the temperature-dependent correction of the position of the piston of the master cylinder.

### BACKGROUND OF THE INVENTION

1. Field of the Invention

The present invention relates to a method for compensating for volume changes of an hydraulic fluid in an hydraulic actuating device for actuating a clutch.

2. Description of Related Art

Hydraulically actuated clutches are used, among other things, as separating clutches between an internal combustion engine and the drive train of motor vehicle hybrid drives, in the form of non-power-splitting-parallel hybrids, in order to decouple the internal combustion engine from the drive train for the purely electrical vehicle operation by opening the separating clutch, or to start it again by closing the separating clutch in case of increased power demand or a low battery charge state, by using the electric machine.

In order to avoid disturbances in the drive train, the separating clutch is controlled during the opening and the closing in such a way that a specified clutch torque or slip torque is present between its clutch disks. For this purpose, an electrohydraulic actuating device is used, which includes an electrically controlled and driven spindle actuator and a master cylinder coupled to the spindle actuator, which is connected by a snifting bore to a reservoir for hydraulic fluid and by an hydraulic line to a slave cylinder. A piston rod connected to a piston of the slave cylinder acts upon a funnel-shaped disk spring, rotating at the rotational speed of the crankshaft of the internal combustion engine, which, between its inner circumference, that is in contact with the piston rod and its outer circumference, that is connected to one of the clutch disks, is supported swivelably on a stationary counter-support. In order to generate the desired clutch torque or slip torque between the clutch disks, the spindle actuator is moved by a certain measure, and consequently also the piston of the master cylinder, whereby hydraulic fluid is squeezed into the slave cylinder, whose piston rod exerts a force upon the disk spring, which then generates a pressure force between the two clutch disks corresponding to the clutch torque or the slip torque. Between the travel path of the spindle actuator and the clutch torque or the slip torque, in this context, there exists a defined relationship which will be designated as the nominal clutch characteristics curve.

In the case of the closed separating clutch and of the unactuated spindle actuator, the snifting bore between the master cylinder and the reservoir having hydraulic fluid is open, so that volume changes in the hydraulic fluid in the master cylinder, in the slave cylinder and in the hydraulic line between the cylinders, caused by temperature fluctuations, are able to be balanced by the snifting bore. When the separating clutch is open in the electric drive operation, the snifting bore is closed, however, whereby in the master cylinder, in the slave cylinder and in the hydraulic line a specified volume of hydraulic fluid is enclosed. A thermal expansion or contraction of this volume therefore leads directly to a change in the force exerted by the piston rod on the disk spring, and, via the latter, on the pressure force of the clutch disks, and consequently to deviations from the desired clutch torque or slip torque.

As has been shown, significant temperature changes are indeed able to occur in the hydraulic fluid, above all when cold hydraulic fluid is squeezed into the hot slave cylinder, when the separating clutch is opened, and heats up within the slave cylinder relatively rapidly, i.e. within a few seconds. Since the hydraulic volume located in the slave cylinder, when the separating clutch is opened, makes up a large proportion of the total volume of the enclosed hydraulic fluid, a volume increase is possible in this case, which results in considerable disturbing effects on the nominal clutch characteristics curve, and, with that, deviations in the desired clutch torque or the slip torque.

### BRIEF SUMMARY OF THE INVENTION

The present invention is based on the object of providing a method and a clutch of the type named at the outset, using which volume changes, caused by temperature fluctuations, in enclosed hydraulic fluid in the master cylinder, in the slave cylinder and in the hydraulic line between the cylinders are able to be balanced.

With respect to the method, the object is attained, according to the present invention, in that the position of the piston of the master cylinder is corrected as a function of temperature, while the object with respect to the clutch is attained, according to the present invention, by means for the temperature-dependent correction of the position of the piston of the master cylinder.

One preferred embodiment of the method, according to the present invention, provides that the position of the piston of the master cylinder be corrected by the controlled actuation of the actuator, in order to retract or advance the piston of the master cylinder corresponding to the thermal expansion or contraction of the hydraulic fluid in the slave cylinder.

A temperature difference between a measured temperature at the slave cylinder and a reference temperature is expediently used as the basis for controlling the actuator.

Since a significant thermal expansion of the hydraulic fluid in the slave cylinder is determined, particularly when cold hydraulic fluid squeezed into the hot slave cylinder, directly after the opening of the clutch, heats up relatively rapidly within the slave cylinder and thereby expands, a further preferred embodiment of the present invention provides that the position of the piston of the master cylinder be corrected directly after the opening of the clutch, preferably according to the following relationship:

I_{corr,GZ}=K_{E}×(t_{NZ}−t_{NZ,Ref})×e_{E}^{(-t/τ)}; (1)

where I_{corr,GZ} is the position correction at the master cylinder, KE is a heating factor, τ_{E} is a time constant for the heating phase of the hydraulic fluid, t_{NZ} is the current temperature at the slave cylinder, and t_{NZ,Ref} is the temperature which has to be present at the slave cylinder at least so that an appropriate heat input into the hydraulic fluid is able to take place.

Since a significant thermal contraction of the hydraulic fluid in the slave cylinder is determined particularly when the hydraulic fluid in the slave cylinder gradually cools off when the clutch is opened, a still further preferred embodiment of the present invention provides for correcting the position of the piston of the master cylinder once more, a short time after opening of the clutch, preferably according to the following relationship:

I_{corr,GZ}=K_{A}×(t_{NZ,Opn}−t_{NZ}) (2)

where I_{corr,GZ} is the position correction at the master cylinder, K_{A} is a cooling factor, t_{NZ,Opn} is the temperature at the slave cylinder at the time of the opening of the clutch and t_{NZ} is the current temperature at the slave cylinder.

The best results are obtained if the values obtained by the above relationships (1) and (2) are superposed on one another or added for the position correction at the piston of the master cylinder.

### BRIEF DESCRIPTION OF THE DRAWINGS

FIG. 1 shows a schematic representation of an hydraulically actuated separating clutch for a motor vehicle hybrid drive.

FIG. 2 shows the pressure curve in the slave cylinder, with and without compensation of volume changes in the hydraulic fluid as a result of temperature fluctuations.

FIG. 3 shows the curve of a nominal clutch characteristics curve of the clutch, which reflects the relationship between a path of motion of an actuator for actuating the clutch and the pressure between two clutch disks of the clutch.

FIG. 4 shows the curve of the nominal clutch characteristics curve, and of deviations of the clutch characteristics curve as a result of operating-conditioned temperature fluctuations.

### DETAILED DESCRIPTION OF THE INVENTION

Separating clutch 2, shown in the drawing, of a non-power-splitting parallel hybrid drive of a motor vehicle is situated between an internal combustion engine of the hybrid drive and a drive train of the motor vehicle. Separating clutch 2 is used, on the one hand, to decouple the internal combustion engine from the drive train upon the transition to electrical driving operation, when the motor vehicle is to be operated only with the aid of an electric machine of the hybrid drive, and on the one hand, upon an increased power requirement and/or upon a low battery charge state, to start the internal combustion engine again for the transition into the hybrid driving operation, using the electric machine.

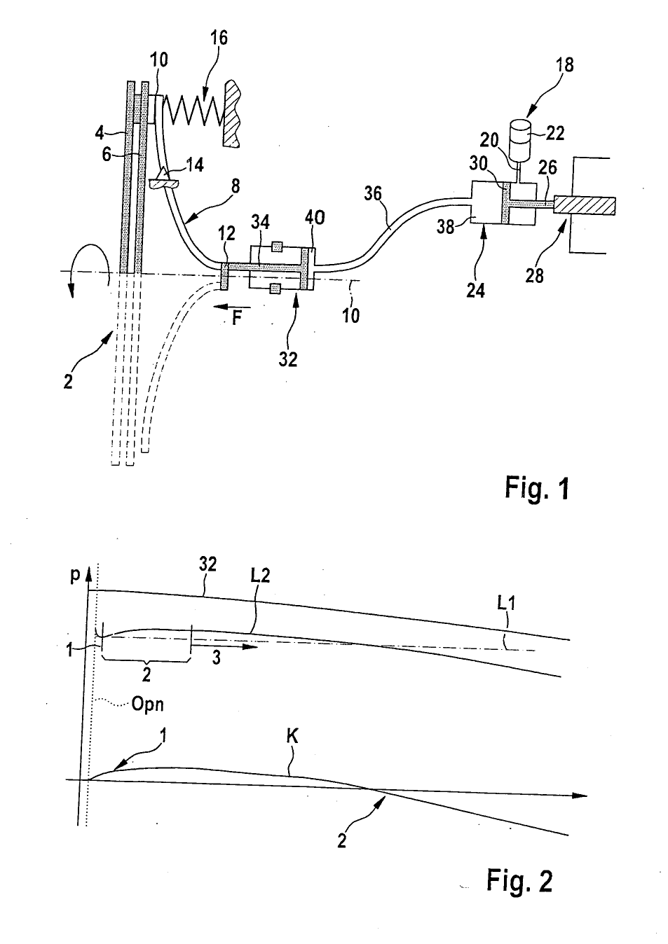

As is shown best in FIG. 1, separating clutch 2 includes two clutch disks 4, 6 and a bent disk spring 8, in the form of a flat funnel, which rotate in common about the rotational axis 10 of the crankshaft of the internal combustion engine. Disk spring 8 is connected at its outer circumference 10 to adjacent clutch disk 6, and is supported swivelably on a stationary counter-support 14 between its outer circumference 10 and a centrical actuating part 12. Separating clutch 2 is normally closed, and is opened for the transition to the electrical driving operation, by having a force F exerted, in the direction of the arrow in FIG. 1, on centrical actuating part 12, in order to swivel disk spring 8 about counter-support 14, and to move clutch disk 6, that is connected to disk spring 8, away from other clutch disk 4, counter to the direction of the arrow in FIG. 1. Closing clutch 2 takes place with the aid of a return spring 16, which acts upon outer circumference 10 of disk spring 8, on the opposite side of clutch disk 6, and there presses the spring, together with clutch disks 6, against other clutch disk 4, when no force F acts upon actuating part 12.

The actuation of separating clutch 2 is performed using an hydraulic actuating device 18, which includes a master cylinder 24 that is connected by a snifting bore 20 to a reservoir 22 for hydraulic fluid, a spindle actuator 28, that is electrically controlled and rigidly connected to a piston rod 26 of master cylinder 24, for displacing a piston 30 of master cylinder 24, as well as a slave cylinder 32, used for disengaging clutch 2, whose piston rod 34 acts upon actuating part 12 of clutch 2. Master cylinder 24 and slave cylinder 32 are connected by a hydraulic line 36, which in each case opens out in cylinders 24 and 32, on the side facing away from piston rod 26 and 34.

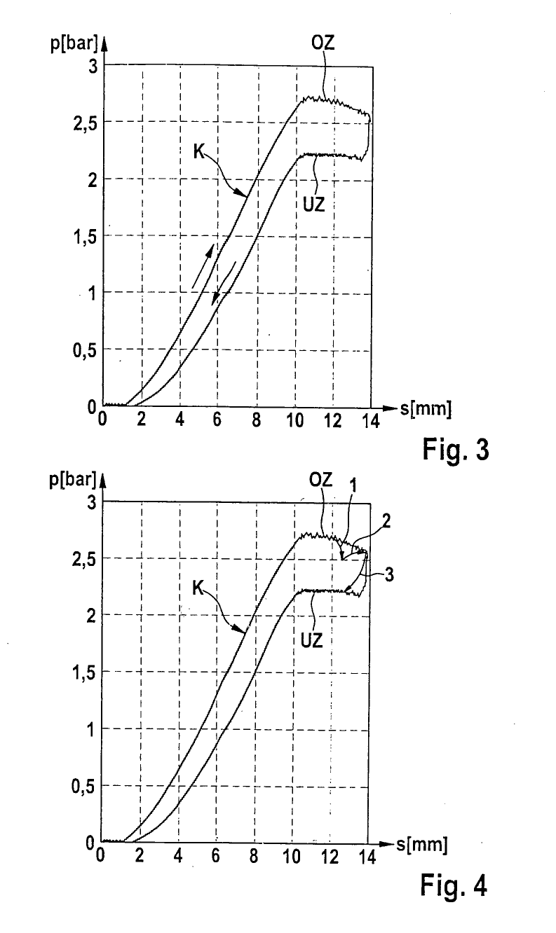

In the operation of separating clutch 2, as a result of the spring characteristics curve of disk spring 8, there comes about a specified pressure/path curve shown in FIG. 3, which reproduces the pressure between the two clutch disks 4, 6 as a function of the travel path of spindle actuator 28, and is usually designated as nominal clutch characteristics curve K of clutch 2. Since the pressure/path curve, during the moving in and out of master and slave cylinders 24, 32, is respectively different, clutch characteristics curve K is a hysteresis.

Snifting bore 20 is situated in master cylinder 24 in such a way that, when clutch 2 is closed, it opens out into a piston chamber 38, of cylinder 24, that communicates with hydraulic line 36, so that an expansion or contraction of the hydraulic fluid volume, conditioned by temperature fluctuations, in piston chamber 38 of master cylinder 24, in hydraulic line 36 and in a piston chamber 40, of slave cylinder 32, that communicates with hydraulic line 36, are able to be balanced.

When clutch 2 is open, however, snifting bore 20 opens out into cylinder 24 on the opposite side of piston 30, as shown in FIG. 1, so that in piston chamber 38 of master cylinder 24, in hydraulic line 36 and in piston chamber 40 of slave cylinder 32 a specified, invariable hydraulic fluid volume is enclosed. An expansion or contraction, conditioned upon temperature fluctuations, of this hydraulic fluid volume therefore leads to a change in force F exerted by piston rod 34 on disk spring 8, and thus to an undesired deviation from nominal clutch characteristics curve K.

An expansion of the hydraulic fluid volume occurs, for example, when the internal combustion engine is operated for a longer period of time at a higher rotational speed, such as during a superhighway trip, whereby slave cylinder 32 heats up greatly, and subsequently there is a transition to electrical driving operation, as, for instance, in a traffic jam situation. In this case, when, for instance, for transition into the electrical driving operation, clutch 2 is opened by moving spindle actuator 28, cold hydraulic fluid is squeezed from master cylinder 24 into hot slave cylinder 32, where it heats up within a few seconds. As a result of the heating up, the enclosed hydraulic fluid, that is for the most part in slave cylinder 32 at open clutch 2, expands.

After the opening of clutch 2, in this context, there comes about a typical pressure/path curve shown in FIG. 4, which, in the upper area of the hysteresis, deviates from the nominal clutch characteristics curve K in phases designated by 1, 2 and 3 in FIG. 4.

Phase 1 represents a brief pressure breakdown, which takes place directly after the opening of clutch 2, and, on the one hand, is caused by a pressure drop as a result of a path reversal of piston rods 28 and 34 of the two cylinders 24 and 32, as well as, on the other hand, by a pressure drop as a result of a decreasing centrifugal force at disk spring 8 and an increase, conditioned by this, of the path of piston rod 34, and leads to a deviation downwards from an upper branch oZ of hysteresis K.

Phase 2 represents a rise again of the pressure, lasting a few seconds, having a subsequent saturation, which is caused by the heat input, described before, from slave cylinder 32 into the hydraulic fluid, and has the effect of running back to the upper branch oZ of hysteresis K.

Phase 3 represents a subsequent pressure drop as a result of the cooling of slave cylinder 32 and the hydraulic fluid contained in it, whereby there is a transition to lower branch uZ of hysteresis K.

The changes conditioned upon temperature fluctuations of the pressure/path curve in phases 2 and 3 are balanced, according to the present invention, by an appropriate correction of the position of piston 30 of master cylinder 24, so as, in the ideal case, during the electrical driving operation, to achieve a constant pressure in piston chamber 40 of slave cylinder 32, as shown in FIG. 2 by dash-dotted line L1 above the three phases 1, 2 and 3. Solid line L2 in this figure represents the curve of the pressure in slave cylinder 32 without compensation.

In phase 2, the expansion of the hydraulic fluid may approximately be given by an exponential function, using which the position correction required at master cylinder 24 may be calculated by the following relationship:

I_{corr,GZ}=K_{E}×(t_{NZ}−t_{NZ,Ref})×e_{E}^{(-t/τ)}

where I_{corr,GZ} is the position correction at master cylinder 24, K_{E} is a heating factor for taking into account the expansion of the hydraulic fluid based on the heat input by slave cylinder 32, τ_{E} is a time constant for the heating phase of the hydraulic fluid, t_{NZ} is the current temperature at slave cylinder 32 and t_{NZ,Ref} is the reference temperature which has at least to be present at slave cylinder 32 so that a corresponding heat input into the hydraulic fluid is able to take place.

It has been shown that a relevant heat input into the hydraulic fluid, and with that a corresponding expansion of same, takes place only when slave cylinder 32 is at a minimum temperature, which correspondingly has to be greater than the average temperature of the hydraulic fluid. Therefore it is meaningful to draw upon the temperature of the hydraulic fluid outside slave cylinder 32 as the slave cylinder reference temperature t_{NZ,Ref}. Since this temperature is usually not known, one may expediently use as slave cylinder reference temperature t_{NZ,Ref} either a constant temperature or the environmental temperature, for example, if master cylinder 24 is installed in a part of the motor vehicle which is at the environmental temperature.

In this context, it is basically not absolutely necessary to know the exact temperature, and thus the exact expansion of the hydraulic fluid. During the electrical driving, because the system is steadily located within the hysteresis of the upper area of clutch characteristics curve K, it is only relevant to know whether an expansion or a contraction of the hydraulic fluid is taking place. Depending on this, the pressure moves either along upper branch oZ or along lower branch uZ of the hysteresis. Since these two branches in the upper area of clutch characteristics curve K run almost horizontally, as shown in FIGS. 3 and 4, the quantity of the expansion or contraction of the hydraulic fluid is of only subordinate importance. Rather, the knowledge of the size of the hysteresis and of the transitional behavior during the transition from upper branch oZ to lower branch uZ, and vice versa, is important

Time constant τ_{E} for the heating phase of the hydraulic fluid is able to be ascertained from appropriate temperature and pressure measurements at slave cylinder 32, and is generally in the range of a few seconds.

The amount of the pressure increase in phase 2 depends, above all, on how far after phase 1 the pressure has broken into the hysteresis. Measurements have shown that the pressure moves back to upper branch oZ of the hysteresis the more certainly, the higher the heat input into the hydraulic fluid in slave cylinder 32.

For phase 3, in which the hydraulic fluid also cools off as a result of the cooling of the system based on the purely electrical driving operation, it may be assumed, with respect to the contraction of the hydraulic fluid, that it takes place proportionally to the temperature reduction of the system. Since it has also been shown that the temperature reduction in the hydraulic fluid is comparable to the temperature reduction of slave cylinder 32, the knowledge of the temperature of slave cylinder 32 is sufficient to estimate the contraction of the hydraulic fluid, whereby the necessary position correction at master cylinder 24 is yielded by the following relationship:

I_{corr,GZ}=K_{A}×(t_{NZ,Opn}−t_{NZ}) (2)

where I_{corr,GZ} is the position correction at master cylinder 24, K_{A} is a cooling factor, t_{NZ,Opn} is the temperature at slave cylinder 32 at the time of the opening of clutch 2 and t_{NZ} is the current temperature at slave cylinder 32.

By the superposition of the two abovementioned relationships (1) and (2), there comes about the overall position correction required for compensating for volume changes of the hydraulic fluid at master cylinder 24, as shown in FIG. 2 by solid line K.

If the pressure in the hydraulic system is not measured continuously, temperature-conditioned deviations of the pressure/path curve are able to be compensated for at least in a controlled form, using the abovementioned relationships (1) and (2), for which, however, an accurate measurement of the hydraulic system (pressure/path characteristics curve, volume distribution, hydraulic geometries, thermal expansion coefficients, time response of heat input, etc.) is required.

It is better to measure the system pressure continuously and to regulate it, using the method according to the present invention, to the desired value, whereby one may balance the disturbances conditioned upon the temperature fluctuations even substantially more accurately.

1-10. (canceled)

11. A method for compensating for volume changes of a hydraulic fluid in an actuating device configured to actuate a clutch, the actuating device including a master cylinder, an actuator connected to a piston of the master cylinder, and a slave cylinder hydraulically connected to the master cylinder for disengaging the clutch, the method comprising:
adjusting the position of the piston of the master cylinder as a function of temperature.

12. The method as recited in claim 11, wherein the position of the piston is adjusted by a controlled actuation of the actuator.

13. The method as recited in claim 12, wherein the position of the piston is adjusted as a function of at least one of: (i) a temperature difference between a measured temperature at the slave cylinder and a reference temperature; and (ii) a temperature difference between a temperature at the slave cylinder in response to opening of the clutch and a current temperature at the slave cylinder.

14. The method as recited in claim 12, wherein the position of the piston is adjusted directly after the opening of the clutch, in order to compensate for a thermal expansion of the hydraulic fluid in the slave cylinder.

15. The method as recited in claim 14, wherein the adjustment of the position of the piston is in accordance with the following relationship (1):
I_{corr,GZ}=K_{E}×(t_{NZ}−t_{NZ,Ref})×e_{E}^{(-t/τ)} (1)
where I_{corr,GZ} is the position correction at the master cylinder, K_{E} is a heating factor for taking into account the expansion of the hydraulic fluid based on the heat input by the slave cylinder, τ_{E} is a time constant for the heating phase of the hydraulic fluid, t_{NZ} is the current temperature at the slave cylinder, and t_{NZ,Ref} is a reference temperature required to be present at the slave cylinder in order for a corresponding heat input into the hydraulic fluid to take place.

16. The method as recited in claim 15, wherein the reference temperature t_{NZ,Ref} is one of a constant value or an environmental temperature.

17. The method as recited in claim 15, further comprising:
providing a second adjustment of the position of the piston, in order to compensate for a thermal contraction of the hydraulic fluid in the slave cylinder.

18. The method as recited in claim 17, wherein the second adjustment of the position of the piston is in accordance with the following relationship (2):
I_{corr,GZ}=K_{A}×(t_{NZ,Opn}−t_{NZ}) (2)
where I_{corr,GZ} is the position correction at the master cylinder (24), K_{A} is a cooling factor, t_{NZ,Opn} is the temperature at the slave cylinder at the time of the opening of the clutch, and t_{NZ} is the current temperature at the slave cylinder.

19. The method as recited in claim 18, wherein the position of the piston is corrected by superposition of relationships (1) and (2).

20. An actuating device for actuating a clutch, comprising:
a master cylinder;
an actuator connected to a piston of the master cylinder;
a slave cylinder connected hydraulically to the master cylinder and configured to selectively disengage the clutch; and
a device configured to perform temperature-dependent correction of the position of the piston of the master cylinder.
